(19) United States
(12) Patent Application Publication
(10) Pub. No.: US 2016/0195704 A1
(43) Pub. Date: Jul. 7, 2016

(54) HIGH-RESOLUTION 3D FLUORESCENCE MICROSCOPY

(71) Applicant: CARL ZEISS MICROSCOPY GMBH, Jena (DE)

(72) Inventors: Thomas KALKBRENNER, Jena (DE); Ingo Kleppe, Jena (DE)

(73) Assignee: Carl Zeiss Microscopy GmbH, Jena (DE)

(21) Appl. No.: 14/911,819

(22) PCT Filed: Jul. 18, 2014
(86) PCT No.: PCT/EP2014/065501

§ 371 Date: Feb. 12, 2016

(30) Foreign Application Priority Data
Aug. 14, 2013 (DE) 10 2013 216 124.7

(51) Int. Cl. G02B 21/16; G02B 21/06; G02B 27/58; G02B 21/36; G01N 21/64

(52) U.S. Cl. CPC G02B 21/16; G02B 21/365; G01N 21/6458; G02B 27/58; G02B 21/06

(57) ABSTRACT

A microscopy method for generating a high-resolution image of a sample. The method includes: a) providing the sample with a substance that emits determined statistically blinking fluorescence radiation after excitation or using a sample containing such a substance; b) directing illumination radiation onto the sample and exciting the sample for emission of fluorescence radiation; c) repeated imaging of the sample along an optical axis on a spatially resolving detector to obtain an image sequence; d) processing the image sequence via a cumulant function that evaluates intensity fluctuations in the image sequence caused by the blinking, and generating an image of a local distribution of the substance in the sample which has a spatial resolution greater than the optical resolution of the imaging. The illumination radiation is beamed so that it excites the sample along the optical axis only in a limited depth region for emission of the fluorescence radiation.

The present application claims priority from PCT Patent Application No. PCT/EP2014/065501 filed on Jul. 18, 2014, which claims priority from German Patent Application No. DE 10 2013 216 124.7 filed on Aug. 14, 2013, the disclosures of which are incorporated herein by reference in their entirety.

### FIELD OF THE INVENTION

It is noted that citation or identification of any document in this application is not an admission that such document is available as prior art to the present invention.

The invention is directed to a microscopy method and a microscope for generating an image of a fluorescing sample which is also highly resolved in depth direction.

The examination of samples by microscopy is a broad technical field for which there are a multitude of technical solutions. A wide variety of microscopy methods have been developed based on conventional light microscopy.

Fluorescence microscopy is a typical area of application of light microscopy for the examination of biological specimens. In fluorescence microscopy, certain dyes (known as fluorophores) are used for specific labeling of samples, e.g., cell parts. As mentioned, the sample is illuminated by excitation radiation and the fluorescence radiation excited in this way is detected by suitable detectors. For this purpose, the light microscope is usually provided with a dichroic beamsplitter combined with blocking filters which split off the fluorescence radiation from the excitation radiation and permit separate observation. This procedure allows individual, differently colored cell parts to be displayed in the light microscope. Naturally, more than one portion of a specimen can also be dyed simultaneously with different dyes which attach themselves specifically to different structures of the specimen. This process is referred to as multiple luminescence. It is also possible to measure samples which luminesce by themselves, that is, without the addition of labeling agents.

Different approaches have recently been developed for resolutions which overcome the diffraction limit set by physical laws. These microscopy methods are characterized in that they afford the user a higher lateral optical resolution compared to the conventional microscope. Such microscopy methods are referred to in the present description as high-resolution microscopy methods, since they achieve a resolution beyond the optical diffraction limit. Diffraction-limited microscopes, on the other hand, are referred to as conventional microscopes.

A high-resolution method of widefield microscopy is known from the publication by T. Dertinger et al., “Fast background-free, 3D super-resolution optical fluctuation imaging (SOFT)”, PNAS (2009), pp. 22287-22292, and “Achieving increased resolution and more pixels with Superresolution Optical Fluctuation Imaging (SOFT)”, Opt. Express, Aug. 30, 2010, 18(18): 18875-85, doi: 10.1364/IE.18.018875, and S Geissbuehler et al., “Comparison between SOFI and STORM”, Biomed. Opt. Express 2, 408-420 (2011). This method utilizes the blinking properties of a fluorophore. When the fluorophores in a sample blink statistically independently of one another, an imaging of the sample through suitable filtering with a so-called cumulant function can achieve a considerable increase in resolution beyond the physically determined optical resolution limit. In order to generate a high-resolution image, a sample is excited and imaged under wide field. In so doing, a sequence of individual images is captured and then combined with the cumulant function to form an individual image which has the higher resolution. This method is referred to as the SOFI method, an abbreviation of the term “Super-resolution Optical Fluctuation Imaging.”

The SOFI method requires a series of images with the most varied possible blinking states of the fluorophores which are to be added to the sample subsequently or which are inherently present in the sample. At the same time, the camera must be capable of temporally detecting this blinking and affording a high spatial resolution simultaneously. When implementing the SOFI principle, it must be ensured that as few fluorophores as possible change their fluorescence state during the acquisition of an individual image and that the fluctuations of individual fluorophores (i.e., the changing of the fluorescent state) are detectable from one individual image to the other. It is for this reason that the SOFT method was applied in the past particularly with respect to thin samples having virtually no depth extension along the optical axis of imaging with respect to the fluorescing material. Accordingly, it could be conceivable to carry out a TIRF illumination of the sample in order to ensure that no fluorophores located behind one another change their fluorescence state during the acquisition of an individual image.

### SUMMARY OF THE INVENTION

It is the object of the invention to provide a high-resolution microscopy method based on the SOFI principle by which thick samples can also be analyzed, i.e., in which the restrictions with respect to the possible samples are eliminated.

This object is met according to the invention through a microscopy method for generating a high-resolution image of a sample having the following steps: a) providing a sample with a substance which emits determined statistically blinking fluorescence radiation after excitation or using a sample containing such a substance; b) directing illumination radiation onto the sample and accordingly exciting the sample for emission of fluorescence radiation; c) repeated imaging of the sample emitting the fluorescence radiation along an optical axis on a spatially resolving detector so that an image sequence is obtained; d) processing the image sequence by means of a cumulant function which evaluates intensity fluctuations in the image sequence caused by the blinking and accordingly generating an image of a local distribution of the substance in the sample which has a spatial resolution that is increased beyond the optical resolution of the imaging; wherein e) the illumination radiation is beamed in such a way that the illumination radiation excites the sample along the optical axis only in a limited depth region for emitting the fluorescence radiation.

According to the invention, the SOFI principle is combined with optical sectioning methods to achieve a high-resolution imaging of the fluorescing sample in depth direction as well. This prevents out-of-focus background during image generation and stressing of the sample by fluorescence excitation in depth portions which are not even imaged.

The optical slicing can be carried out in different ways. In one embodiment form, a so-called temporal focusing is used such as is described, for example, in the applicant's own DE 102009060793 A1. In another embodiment form, a light sheet arranged transverse to the optical axis of the imaging is beamed in.

A further embodiment form uses multiphoton processes for generating the blinking states in the sample. This is surprising inasmuch as a direct multiphoton excitation requires a point scanner which should be ruled out a priori for the SOFT principle because it would require a scanned image construction. The SOFI principle demands that the entire sample be imaged simultaneously in different blinking states and so cannot be reconciled with a scanned image construction. Nevertheless, a multiphoton effect can be used for optical slicing with the SOFI principle by using a substance which can be switched between a first state and a second state through irradiation with optical switching radiation. The substance can be excited for emitting fluorescence radiation only in the second state. Accordingly, the sample can be prepared with a scanned switching such that only deliberately selected depth regions can be made to blink in a subsequent fluorescence excitation step. The sample then fluoresces two-dimensionally only in the depth regions that were previously selected through the scanned multiphoton effect. The switching radiation is applied in a scanned manner, preferably with a multiphoton process which allows a particularly narrowly delineated depth region to be defined. Naturally, the switching radiation can also be applied by means of temporal focusing to carry out the multiphoton excitation in a depth-selective manner without raster scanning.

When the sample has been prepared in a depth-selective manner, the subsequent excitation of the sample is carried out without further structuring, since the sample was only switched in the previously prepared depth regions and can accordingly only exhibit the blinking behavior required for the SOFI principle in those regions.

The above-mentioned sample preparation by means of switching radiation ensures that only a selected depth region exhibits a determined blinking behavior which is then evaluated in the SOFT process. One or more of the following quantities can be used as blinking parameters: dark period, probability of transition between dark state and bright state of the blinking, bright-dark time ratio of blinking.

For the SOFI principle, the aim is to optimize the ratio of dark and bright times of the blinking and the blinking probability of the fluorophores. A ratio of bright to dark fluorophores of 1:1 is optimal because one half of all of the fluorophores luminesce on the average in each individual image. If this is achieved, the number of required individual images is minimized.

Therefore, it is preferable in the interest of the fastest possible image acquisition to adjust a bright-to-dark time ratio of the blinking by a suitable setting of the switching radiation and preferably to adapt this ratio to the individual image acquisition rate of the detector. Further, a blinking parameter of the marker or sample can be adapted through the above-mentioned illumination parameters, which blinking parameter influences the dark period and/or a probability of transition between dark state and bright state of the blinking, the aim in both cases being to achieve or approach the optimum ratio of 1:1.

In addition to influencing through illumination radiation, a manipulation of the substance can be achieved by means of chemical control of a lifetime of the relevant molecules in which fluorescence radiation is emitted (bright state) or no fluorescence radiation is emitted (dark state). In so doing, the aim is a population number of the states which achieve a probability of transition between bright and dark of 0.5 with the same lifetimes.

### BRIEF DESCRIPTION OF THE DRAWINGS

FIG. 1 shows a block diagram of an embodiment form of a microscopy method for generating an image which also has high resolution in depth direction.

FIG. 2 shows a schematic representation of a microscope for carrying out the method of FIG. 1.

FIG. 3 shows a schematic representation of a further microscope for carrying out the method.

FIG. 4 shows a block diagram similar to FIG. 1 for a further embodiment form of the method which can be carried out with modified construction of the microscope from FIG. 2 or FIG. 3.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

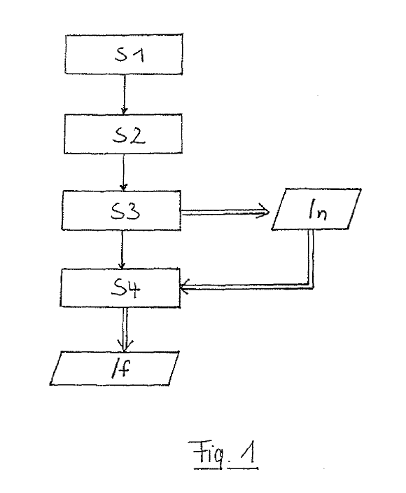

FIG. 1 shows a block diagram of a first embodiment form of a microscopy method for generating an image which also has high resolution in depth direction.

In step S1, a sample is provided with a marker which is the substance mentioned in the introduction which emits determined statistically blinking fluorescence radiation after excitation. Alternatively, a sample already containing the substance is selected.

In a subsequent step S2, the sample is irradiated by illumination radiation and the emission of the particular fluorescence radiation of the substance in the sample is excited. The illumination radiation is beamed in by means of an optical slicing method such that it excites the sample along the optical axis of a subsequent imaging only in a limited depth region for the emission of fluorescence radiation. This limited depth region determines the resolution in depth direction.

Subsequently in a step S3, the sample is repeatedly imaged and a different blinking state of the sample is present in every image due to the blinking behavior. Accordingly, the repeated imaging generates an image sequence In. In a subsequent step S4, this image sequence In is processed by means of a cumulant function which evaluates intensity fluctuations in the image sequence which are caused by the blinking. In this way, an image If is generated which has a spatial resolution that is increased beyond the optical resolution of the imaging. The method of steps S3 and S4 corresponds to the known SOFI principle, for example, according to the above-cited publication by Dertinger et al. However, the difference consists in that, due to the configuration of step S2, the sample emits blinking fluorescence radiation only in a narrowly defined depth region. Accordingly, the image If renders the sample exclusively in this depth region.

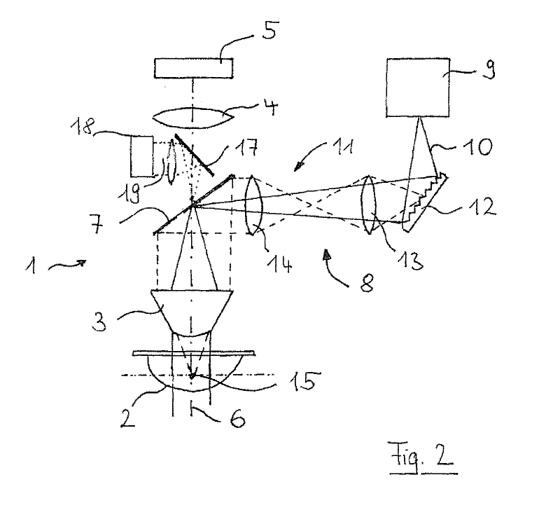

FIG. 2 shows a microscope 1 which can be used to carry out the method of FIG. 1. FIG. 2 shows two different embodiment forms for the microscopy method. Elements 17 to 19 and the dotted beam path in FIG. 2 do not relate to the embodiment form of the method according to FIG. 1. Therefore, these components of FIG. 2 will not be discussed until later and do not play any role for the time being.

A sample 2 is located behind a coverslip, not shown in more detail. It is imaged on a detector 5 by the microscope 1 via an objective 3 and a tube lens 4. To this extent, it corresponds to a known microscope construction. A beamsplitter 7 by which an illumination beam path 8 is coupled in is located in the imaging beam path. The beamsplitter 7 has a beam-shaping device 11 which introduces the radiation into the sample 2 via the microscope 3.

The illumination beam path 8 comprises an illumination source 9 which emits the illumination radiation 10. The illumination radiation 10 is pulsed and is radiated in by means of temporal focusing such that it has a determined pulsed time behavior only in a limited depth region. The pulse duration is minimized only in a limited depth region of the sample. Temporal focusing of this type is known, for example, from the applicant's own DE 1020090600793 A1. The principle is known, for example, from publications by Oron et al., Optics Express 13, 1468 (2005), or Vaziri et al., PNAS 105-20221 (2008). Therefore, as regards the functional principle and the configuration of the elements in the illumination beam path 8, these texts are referred to expressly and their disclosures are incorporated herein in their entirety.

The illumination source 9 emits the pulsed illumination radiation 10. It is deflected via a scattering element which is constructed as a grating 12 in the embodiment form shown in FIG. 2. Instead of a grating 12, other dispersive elements can also be used, e.g., a DMD, LDC filter, LCoS or a dispersive element. The radiation is imaged by optics 13 and 14 and via the beamsplitter 7 and objective 3 in such a way that the pulsed radiation regains the pulse length by which it was emitted by the illumination source only in an image plane 15. Ideally, exactly the same pulse length is present again in the image plane 15. In reality, a somewhat longer pulse length is present in the image plane 15 due to dispersive elements in the beam path downstream of the scattering element; nevertheless, the shortest pulse length in the beam path downstream of the scattering element is present in image plane 15. Accordingly, the illumination source 9 emits a pulsed raw beam which is modified via the scattering element and optics such that the minimal pulse length downstream of the scattering element is first given again in image plane 15 which lies in the sample 2. The pulse length is greater above and below image plane 15.

In FIG. 2, the beam path of the illumination beam path 8 is shown in solid lines. The radiation of an element of the grating 12 is shown in dashes. As can be seen, the radiation incident upon the grating element of the grating 12 is spectrally split. The spectral components of the radiation have the same running duration only for image plane 15 so that the pulses of the raw beam as it comes from the illumination source 9 are reconstructed to form pulses with minimal pulse length only in image plane 15. This applies in the entire image plane 15 as is shown by the solid illumination beam path. By choosing the substance such that it is only excited for emission of blinking fluorescence radiation suitable for SOFT by pulsed radiation with the pulse length of the raw beam, the required depth selection can accordingly be realized through the microscope according to FIG. 2 when beaming in the illumination radiation 10. This takes place under wide field illumination as is illustrated by the beam path in solid lines.

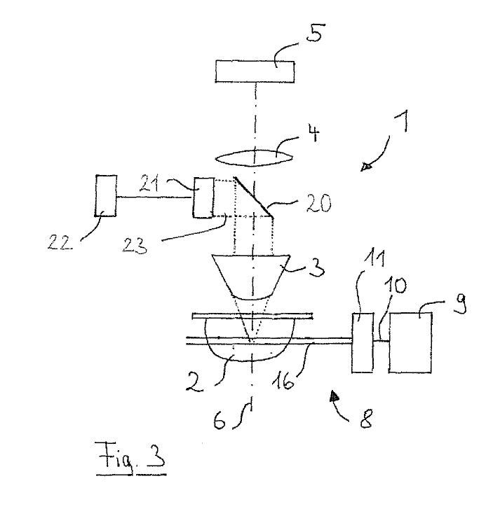

FIG. 3 shows a further embodiment form of the method of FIG. 1 in the form of a schematically shown microscope 1. Elements corresponding to those in FIG. 2 with respect to function or structure have the same reference numerals so as to obviate repetition in the description.

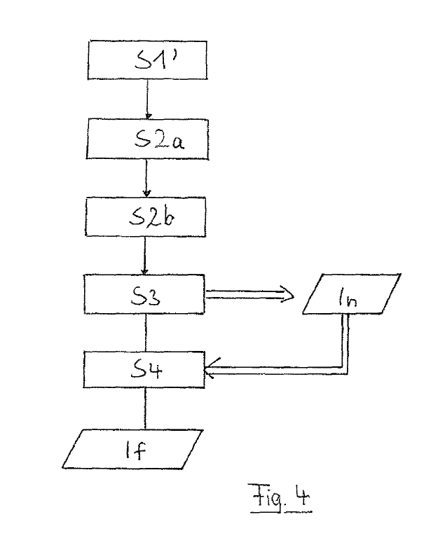

A variant which is not to be described until later with reference to FIG. 4 is likewise shown in FIG. 3 with elements 17 to 19 and the dotted beam path. Microscope 1 in FIG. 3 differs from the microscope in FIG. 2 substantially through the illumination beam path 8. The illumination source 9 in this case emits a light beam which is likewise modified by a beam-shaping device 11. Whereas in FIG. 2 the beam-shaping device 11 is still formed through the grating 12 and optics 13 and 14 for optical slicing by temporal focusing, the beam-shaping device 11 in FIG. 3 causes the illumination radiation to be beamed in in the shape of a light sheet 16 transverse to the optical axis 6 of the microscope 1. The sample 2 is accordingly irradiated only in the area of the light sheet 16 which consequently determines the depth plane.

FIG. 4 schematically shows a further embodiment form of the microscopy method. With respect to step S3 and step S4, it corresponds to that of FIG. 1 so that a description of these steps can be omitted to avoid repetition. The differences consist in the configuration of step S2 which has two parts in the embodiment form in FIG. 4. It comprises two steps S2a and S2b. Step S1 is also modified to a step S1′. A sample is prepared in this step S1′, the substance of which is switched through a multiphoton effect to a fluorescent state in which it emits the fluorescence radiation with statistical blinking behavior that is suitable for SOFT. In other words, the sample (i.e., its fluorescing molecules) can only be excited after a switching radiation is switched on. In regions in which the switching radiation was not switched on, the sample shows no fluorescence behavior suitable for SOFI, or ideally any fluorescence at all, even when the excitation radiation is beamed in. Therefore, step S1′ includes labeling a sample with a substance or selecting a sample containing inherently suitable substances which, by means of switching radiation, can be brought to a state in which it can be excited for emission of fluorescence radiation by beaming in excitation radiation.

Accordingly, in the embodiment form of FIG. 4, the illumination radiation which was beamed in in step S2 of the embodiment form from FIG. 1 comprises two components, a switching radiation and an excitation radiation. Consequently, step S2 is divided into two steps S2a and S2b. In step S2a, the switching radiation is beamed in. This takes place in such a way that the required depth region is selected. In step S2b, the excitation radiation is beamed into the sample. Here, there is no further need for a depth selection because the sample can emit fluorescence radiation only in those regions which were previously switched by the irradiation in step S2a.

Providing the illumination radiation in two steps has a key advantage. A scanning process can be used for introducing the switching radiation. Scanning solutions are, in and of themselves, incompatible with the SOFI principle because the sample must be imaged in its entirety simultaneously in order to have the different blinking states in the image sequence In. Accordingly, a scanning image acquisition in which different regions of the image are acquired consecutively is ruled out. Nevertheless, in the method shown in FIG. 4, the switching radiation can be applied in a scanning manner, i.e., individual portions of the sample are scanned one after the other, since the excitation of fluorescence radiation is not carried out until later in step S2b—of course, using wide field as is also the case for the imaging (step S3).

Accordingly, the sample is scanned when a corresponding substance has been used in step S1′ which is switched via a multiphoton effect.

Alternatively, temporal focusing is possible in step S2a, for example. Therefore, the microscope in FIG. 2 is structured for an alternative embodiment form of the method in contrast to the previously described construction in such a way that the illumination source 9 supplies the switching radiation in a pulsed manner. The pulse length and, therefore, the intensity which is required for the multiphoton process is present exclusively in image plane 15. Accordingly, step S2a is realized through the illumination beam path 8 and the corresponding operation of the illumination source 9. A beamsplitter 17 which couples light—which then functions as excitation radiation 19—from a radiation source into the beam path of the microscope 1 is additionally provided for carrying out step S2b. The sample is illuminated under wide field. Exclusively the previously prepared regions in the image plane 15 then emit statistically blinking fluorescence radiation. Accordingly in the modified construction, the illumination radiation is realized through the combination of illumination beam path 8 and excitation beam path (realized through elements 17 to 19). Scanning of the switching radiation is not strictly required in this embodiment form because the depth selection is already implemented by the temporal focusing.

FIG. 3 shows a microscope for the embodiment form of the method according to FIG. 4—in this case a scanned sample preparation through multiphoton process. In this embodiment form, the elements 9 to 11 are modified (not shown) in such a way that they cause a widefield illumination of the sample 2 with excitation radiation. This excitation can take place transverse to the optical axis 6, but alternatively also along the optical axis 6. In addition, a beamsplitter 20 is provided. The beamsplitter 20 is supplied with radiation from a scanner 21 which scanningly deflects a raw beam from a switching radiation source 22. Accordingly, a switching beam 23 is provided which scans along the sample 2. By means of multiphoton effect, it causes the substance sample 2 to switch into a state in which it can excite the excitation radiation. Owing to the multiphoton process, the necessary intensity is provided for switching the substance only in a narrowly limited depth region of the sample 2. Accordingly, step S2a is carried out by suitable control of the scanner 21 and switching radiation source 22, and step S2b is carried out through suitable control of the radiation source 9.

In all of the embodiment forms of the microscope, a control device (not shown) is provided which suitably controls the components of the microscope for carrying out the method of FIG. 1 or FIG. 4.

The image sequence In of individual images is assembled into the high-resolution image If in the SOFI processing S4. The principle described by Dertinger et al., for example, is used for this purpose. Similarly, the concept according to WO 2010/141608 A1 which improves over the principle of Dertinger et al. can also be used. This publication is also incorporated herein in its entirety.

The blinking of the fluorophores required for the SOFI principle is defined by a transition from a first, fluorescing state into a second, non-fluorescing state. By non-fluorescing state is meant any state in which the fluorescence radiation which is evaluated for the image is not emitted. Accordingly, the non-fluorescing state can also be a state in which a fluorophore luminesces in a different fluorescence spectral region.

As is known, for example, from the publication by Heilemann et al., Angewandte Chemie 121, p. 7036, 2009, the probability of transition from the first state to the second state can be modified, for example, through chemical influences, temperature influences or illumination influences.

The SOFI principle is particularly efficient when the proportion of luminescing fluorophores to non-luminescing fluorophores is 1:1 for the respective image acquisition rate or image integration time. With these two states having the same lifetimes, the probability of transition between the first state and the second state and between the second state and the first state is ideally 0.5. This can be achieved through appropriate manipulation of the sample by means of chemical action, temperature action or illumination action. By optimizing the beamed-in spectral distribution, the probability of transition can be optimized with the aim of achieving the aforementioned optimum ratio of 1:1. Therefore, the SOFI principle demands transition probabilities which differ substantially from other microscopy methods. The PALM principle (also known as dSTORM), for example, requires states in which the overwhelming proportion of fluorophores is in a dark state.

In order for one half of the fluorophores, if possible, to be in a bright state, the dark period must also be taken into account in addition to the transition probability. Even if the probability of transition from bright to dark is 0.5, the optimal ratio of 1:1 would not be achieved if the lifetime of the dark states were very much longer. Therefore, in a particularly preferred manner the means employed in the prior art for modifying the transition probability and dark period are used (also entirely independent of the imaging of an image sequence which can be smaller than a sample field) to optimize the ratio of luminescing fluorophores to non-luminescing fluorophores toward the optimum value of 1:1 in that the transition probability and/or dark lifetime (or bright lifetime) are/is suitably adjusted and adapted to the image acquisition rate or image integration time. Conversely, it is possible to adapt the acquisition rate to the lifetimes.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A microscopy method for generating a high-resolution image of a sample, the method comprising the following steps:
a) providing the sample with, or using a sample containing, a substance that emits determined statistically blinking fluorescence radiation after excitation;
b) directing illumination radiation onto the sample and accordingly exciting the sample for emission of fluorescence radiation;
c) obtaining an image sequence by repeated imaging of the sample emitting the fluorescence radiation along an optical axis on a spatially resolving detector;
d) processing the image sequence by utilizing a cumulant function that evaluates intensity fluctuations in the image sequence caused by the blinking, and accordingly generating an image of a local distribution of the substance in the sample which has a spatial resolution that is increased beyond the optical resolution of the imaging,
wherein the illumination radiation beamed in such a way that the illumination radiation excites the sample along the optical axis only in a limited depth region for emission of the fluorescence radiation.

2. The microscopy method according to claim 1;
wherein the illumination radiation is beamed in by utilizing temporal focusing on the limited depth region.

3. The microscopy method according to claim 2;
wherein a pulsed raw beam having a pulse length is provided for illumination radiation and is directed to a scattering element that lies in a plane that is imaged by means of optics in an image plane lying in the sample, so that the illumination radiation has:
a minimal pulse length only in the image plane within the sample; and
an increased pulse length, between the image plane and the scattering element, that is greater than the minimal pulse length and greater than the pulse length of the raw beam.

4. The microscopy method according to claim 1;
wherein the illumination radiation is only beamed in a light sheet transverse to the optical axis and is accordingly restricted to the limited depth region.

5. The microscopy method according to claim 1;
wherein the substance is configured to be switched between a first state and a second state by beaming in optical switching radiation, where the substance cannot be excited for emission of the fluorescence radiation in the first state and can be excited for emission of the fluorescence radiation in the second state; and
wherein, in step b), the irradiation by illumination radiation comprises irradiation by optical switching radiation, where the optical switching radiation adjusts a blinking parameter of the determined fluorescence radiation.

6. The microscopy method according to claim 5;
wherein the optical switching radiation causes a switching of the substance through a two-photon effect, and the sample is scanned by the optical switching radiation; and
wherein a focal plane in the sample which defines the depth region is scanned.

7. The microscopy method according to claim 5;
wherein irradiation by the optical switching radiation is limited to the defined depth region by means of temporal focusing.

8. The microscopy method according to claim 2;
wherein a pulsed raw beam having a pulse length is provided for the optical switching radiation and is directed to a scattering element lying in a scattering plane that is imaged by optics in an image plane lying in the sample so that the optical switching radiation has the pulse length of the raw beam within the sample only in this the image plane.

9. The microscopy method according to claim 5;
wherein the optical switching radiation is only beamed in in a light sheet transverse to the optical axis and is accordingly restricted to the limited depth region.

10. The microscopy method according to claim 5;
wherein the blinking parameter includes at least one parameter selected from the group consisting of:
a dark period;
a probability of transition between dark state and bright state of the blinking; and
a bright-dark time ratio of blinking.
